(19) United States
(12) Patent Application Publication
(10) Pub. No.: US 2013/0075456 A1
(43) Pub. Date: Mar. 28, 2013

(54) COMPACTOR WHEEL ASSEMBLY

(71) Applicants: Michael Hans Hinrichsen, Congerville, IL (US); Rammagy Yoeu, Dunlap, IL (US)

(72) Inventors: Michael Hans Hinrichsen, Congerville, IL (US); Rammagy Yoeu, Dunlap, IL (US)

(21) Appl. No.: 13/622,577

(22) Filed: Sep. 19, 2012

Related U.S. Application Data
(60) Provisional application No. 61/538,379, filed on Sep. 23, 2011.

(51) Int. Cl. B23K 31/02; B23P 17/00; B23K 1/19

(52) U.S. Cl. 228/262.42; 228/101; 228/262.9; 29/894.3

(57) ABSTRACT

A method is disclosed of forming a wheel tip assembly for a compactor wheel assembly used on a compactor machine. The method may include forming a tip portion of white cast iron, and forming a base portion configured to be connected to a wheel rim. The tip portion may be brazed to the base portion to thereby form the wheel tip assembly. Also disclosed is a method of forming a compactor wheel assembly for use on a compactor machine, which includes the wheel tip assembly.

### CROSS-REFERENCE TO RELATED APPLICATION

This application claims priority to provisional application No. 61/538,379, filed Sep. 23, 2011, the disclosure of which is incorporated herein by reference in its entirety.

### TECHNICAL FIELD

The present disclosure relates generally to a mobile machine such as a soil compactor or a landfill compactor, and more particularly to a wheel assembly for the compactor as well as a method of forming the wheel assembly for the compactor.

### BACKGROUND

On a work site, such as a construction site, a demolition site, a mining site, a landfill, or any other site where work is being done, it may be desirable to compact, tear, and/or shred soil, gravel, trash, and/or other material on the ground surface. This may be accomplished by using a type of mobile machine referred to as a “compactor machine” or “compactor”. The compactor may include four wheel assemblies, for example, and each of the wheel assemblies may include a number of wheel tip assemblies connected to a wheel rim. The tip assemblies may be sized, shaped, and located on the wheel rim so as to concentrate the weight of the compactor on the material underneath the wheel assemblies. As a result, when the compactor is driven over the ground surface, the material underneath the wheel assemblies may be effectively compacted, torn, and/or shredded.

It is known to manufacture tip assemblies both from materials that are sufficiently strong or tough to resist breakage or premature wear, as well as materials that permit the tip assemblies to be easily welded to the wheel rim. For example, it is known to form a tip assembly that includes a white iron tip portion to contact the material to be compacted, and a low-carbon, low-alloy steel base portion to be welded to the wheel rim. In order to form this tip assembly, the steel base portion is first formed, then the white iron tip portion is molded or cast directly onto the steel base portion, and then the entire tip assembly is welded to the wheel rim. This avoids difficulties associated with attempting to weld a white cast iron tip to a steel base portion.

This tip assembly suffers from numerous disadvantages, however. For example, the above-described method results in the formation of a solid body, and thus the tip assembly is relatively heavy. Further, when the tip portion becomes worn or breaks off during use, the entire tip assembly must be replaced. Still further, heat treatment of the white iron tip, which might otherwise be used to strengthen the tip portion, may be impossible, because the heat treatment may weaken the connection between the white iron tip and the steel base.

The disclosed compactor wheel assembly and method of forming the compactor wheel assembly may overcome one or more of the disadvantages set forth above, or other disadvantages of other known assemblies or methods.

### SUMMARY

The disclosure may provide a method of forming a wheel tip assembly for a compactor wheel assembly used on a compactor machine. The method may include forming a tip portion of white cast iron, and forming a base portion configured to be connected to a wheel rim. The tip portion may be brazed to the base portion to thereby form the wheel tip assembly.

The disclosure may further provide a method of forming a compactor wheel assembly for use on a compactor machine. The method may include forming a wheel tip assembly by forming a tip portion of white cast iron, forming a base portion configured to be connected to a wheel rim, and brazing the tip portion to the base portion to thereby form the wheel tip assembly. The wheel tip assembly may then be connected to the wheel rim.

The disclosure may still further provide a method of forming a compactor wheel assembly for use on a compactor machine. The method may include forming a tip portion of a wheel tip assembly, the tip portion being formed of white cast iron, and forming a base portion of the wheel tip assembly. The base portion may be connected to a wheel rim. The tip portion may be brazed to the base portion previously-connected to the wheel rim, to thereby form the wheel tip assembly.

### BRIEF DESCRIPTION OF THE DRAWINGS

FIG. 1 is an isometric pictorial view of a compactor wheel assembly, consistent with the disclosure;

FIG. 2 is an isometric pictorial view of a wheel tip assembly of the compactor wheel assembly of FIG. 1, consistent with the disclosure;

FIG. 3 is a side pictorial view of the wheel tip assembly of FIG. 2; and

FIG. 4 illustrates an exemplary method of forming the compactor wheel assembly, consistent with the disclosure.

### DETAILED DESCRIPTION

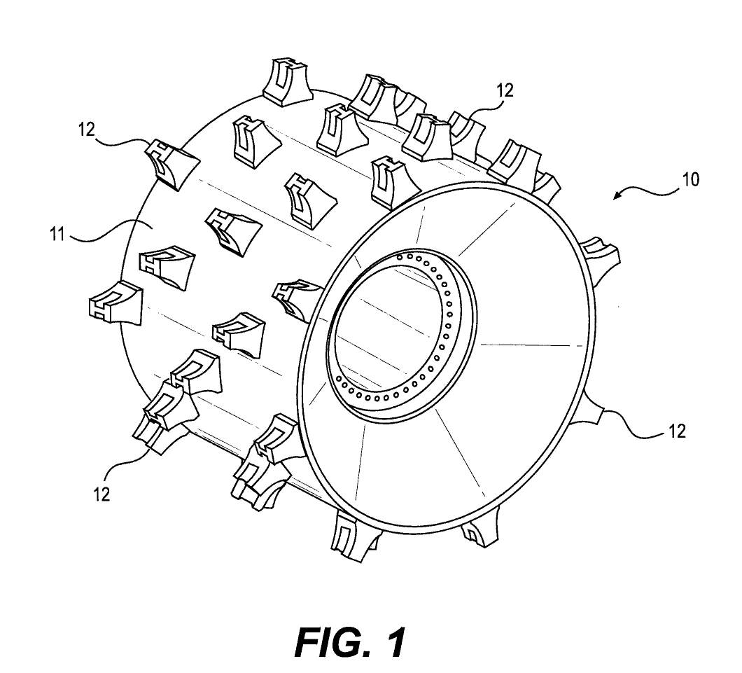

FIG. 1 illustrates a compactor wheel assembly 10, consistent with the disclosure. Compactor wheel assembly 10 may include a wheel rim 11, as well as a plurality of wheel tip assemblies 12 that are connected to wheel rim 11. Compactor wheel assembly 10 may be used on a mobile machine, such as a landfill compactor, a soil compactor, or another type of compactor, which may include four wheel assemblies 10. Wheel tip assemblies 12 on each of the wheel assemblies 10 may concentrate the weight of the compactor, such that the compactor may effectively compact, tear, and/or shred soil, gravel, trash, and/or other material over which the compactor travels. Compactor wheel assembly 10 is not limited to use on a landfill compactor or a soil compactor, however, and may be used on any other type of compactor or mobile machine that compacts, tears, and/or shreds material under its wheels. Regardless of the type of machine, the machine may include more or fewer than four wheel assemblies 10. Each compactor wheel assembly 10 also is not limited to having a particular number of wheel tip assemblies 12 connected to wheel rim 11. For example, each compactor wheel assembly 10 may have more or fewer wheel tip assemblies 12 than are shown in FIG. 1, and each of the wheel assemblies 10 on the same machine may have the same number or a different number of wheel tip assemblies 12.

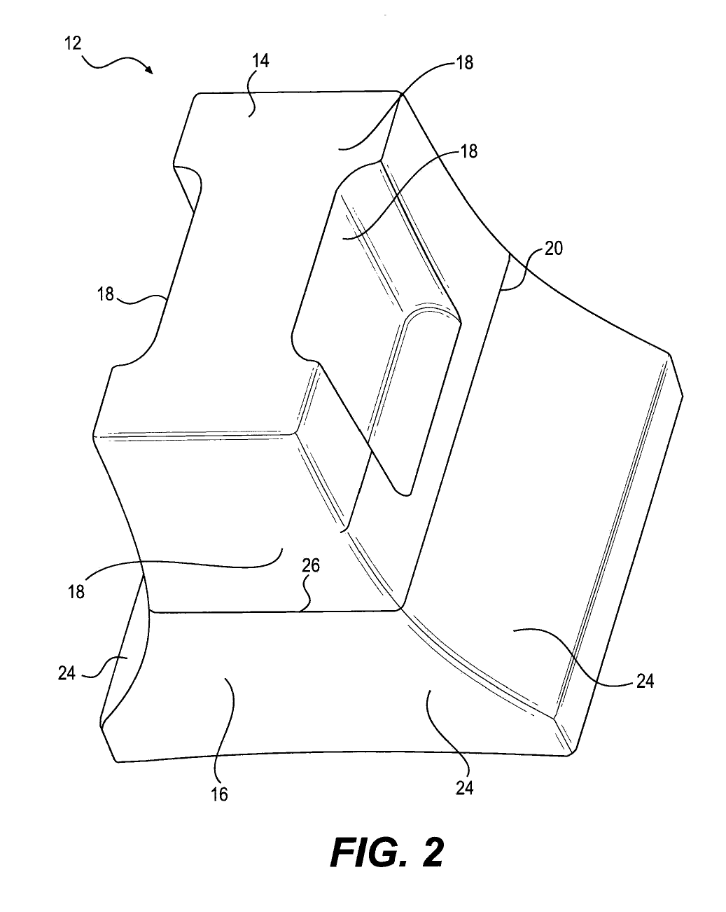

As shown in FIG. 2, each wheel tip assembly 12 may include a tip portion 14 and a base portion 16. Tip portion 14 may include one or more ground-engaging surfaces 18 and a base-engaging surface 20. Ground-engaging surfaces 18 may be configured to contact the soil or landfill material, for example, during use of wheel tip assembly 12, when tip portion 14 is attached to base portion 16. Ground-engaging surfaces 18 may be configured to provide the desired compacting, tearing, and/or shredding of material underneath compactor wheel assembly 10, depending on a desired use of wheel assembly 10.

Base-engaging surface 20 of tip portion 14 may be configured to face and to contact base portion 16 when tip portion 14 is connected to base portion 16 (discussed in detail below). Base-engaging surface 20 may have a contour that approximately matches a corresponding contour on base portion 16, to thereby permit connection of tip portion 14 to base portion 16. As shown in FIG. 2, base-engaging surface 20 may be approximately flat when the corresponding surface of base portion 16 is approximately flat. However, neither base-engaging surface 20 nor the corresponding surface of base portion 16 is required to be flat, and the contour of base-engaging surface 20 is not required to be the same as the contour of the corresponding surface of base portion 16.

Base portion 16 may include one or more ground-engaging surfaces 24 and a tip-engaging surface 26. Ground-engaging surfaces 24 may be configured to contact the soil or landfill material, for example, during use of wheel tip assembly 12, when tip portion 14 is attached to base portion 16. Ground-engaging surfaces 24 may be configured to provide the desired compacting, tearing, and/or shredding of material underneath compactor wheel assembly 10, depending on a desired use of wheel assembly 10.

Tip-engaging surface 26 of base portion 16 may be configured to face and to contact tip portion 14. Tip-engaging surface 26 may have a contour that approximately matches a corresponding contour of base-engaging surface 20 of tip portion 14, to thereby permit connection of tip portion 14 to base portion 16 (discussed in detail below). As shown in FIG. 2, and as discussed above, tip-engaging surface 26 may be approximately flat when base-engaging surface 20 is approximately flat. However, neither tip-engaging surface 26 nor base-engaging surface 20 is required to be flat, and the contour of tip-engaging surface 26 is not required to be the same as the contour of base-engaging surface 20.

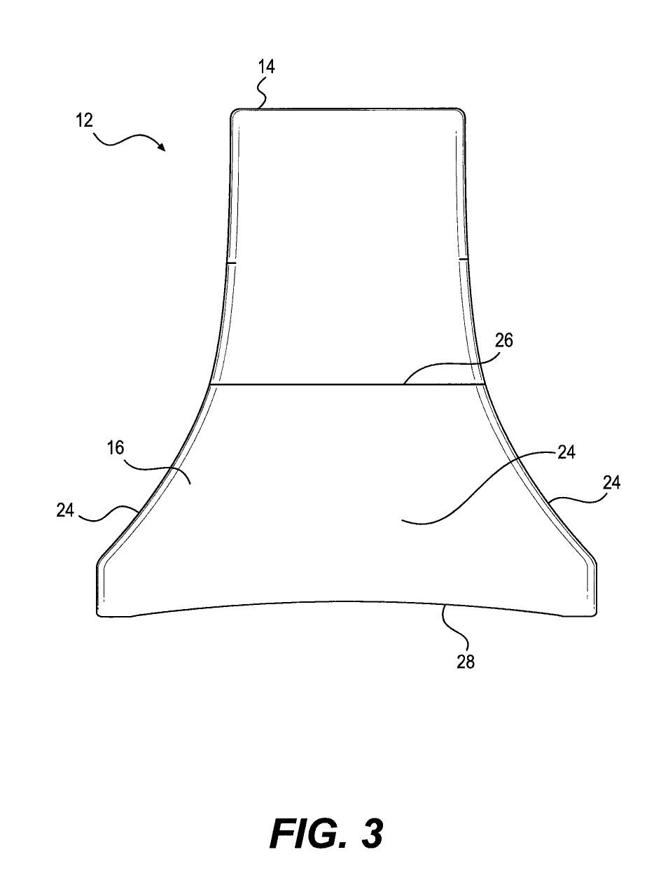

FIG. 3 shows a side view of wheel tip assembly 12, including tip portion 14 connected to base portion 16. As shown in FIG. 3, base portion 16 may include a wheel-engaging surface 28. Wheel-engaging surface 28 may be formed generally opposite tip-engaging surface 26, with ground-engaging surfaces 24 extending therebetween. Wheel-engaging surface 28 may be configured to face and contact a surface of wheel rim 11. Wheel-engaging surface 28 may have a diameter approximately the same as a diameter of the surface of wheel rim 11, to thereby facilitate connection of base portion 16 to the surface of wheel rim 11.

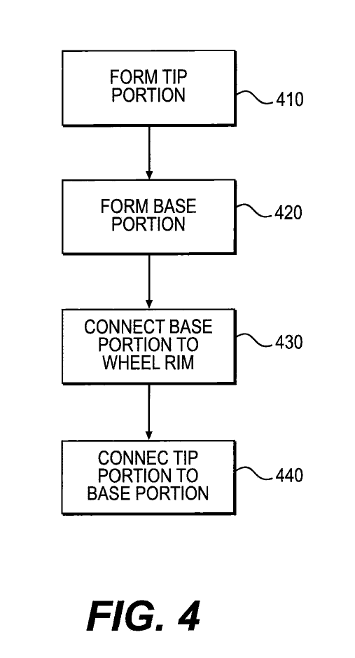

In accordance with disclosed embodiments of wheel tip assembly 12, connection of base portion 16 with wheel rim 11, as well as connection of base portion 16 with tip portion 14, are discussed below with reference to FIG. 4.

### INDUSTRIAL APPLICABILITY

The disclosed compactor wheel assembly may be used on any type of mobile machine, such as for example a landfill compactor, a soil compactor, or any other compactor that is used to shred, tear, and/or compact material underneath the machine. The following discussion, with reference to FIG. 4, provides an exemplary process for assembling components of wheel assembly 10.

As shown in FIG. 4, in Step 410 tip portion 14 may be formed. For example, tip portion 14 may be formed from a steel that is selected to provide desired performance and/or to resist undesired wear during shredding, tearing, and/or compacting of materials by wheel tip assembly 12. Consistent with the disclosure, tip portion 14 may be formed from white cast iron, which exhibits relatively high hardness. In accordance with the disclosure, tip portion 14 is not limited to being formed solely by casting, and also may be formed from other manufacturing processes, such as material removal processes, molding processes, joining processes, and/or combinations of these processes. Further, tip portion 14 is not limited to being formed solely from white cast iron, and may include other materials.

In Step 420 base portion 16 may be formed. For example, base portion 16 may be formed from a relatively easily weldable material, such as a steel that is selected for excellent weldability characteristics, to thereby facilitate welding to wheel rim 11. Examples of such materials include, but are not limited to, a low carbon, low alloy (less than 8% alloying agents by weight) steel. Thus, base portion 16 may be formed from a material that is relatively softer than that of tip portion 14. In accordance with the disclosure, tip portion 14 and base portion 16 may be separately manufactured, permitting the use of dissimilar materials and manufacturing processes. Base portion 16 may be formed from one or more manufacturing processes such as material removal processes, molding processes, casting processes, joining processes, and/or combinations of these processes. However, base portion 16 is not limited to being manufactured by any particular manufacturing process, and is not limited to being formed from any particular material.

In accordance with the disclosure, Steps 410 and 420 may be carried out at the same time, or may be carried out at different times. Further, these steps may occur in any order, such that base portion 16 may be formed (Step 420) either prior or subsequent to formation of tip portion 14 (Step 410). Still further, a number of tip portions 14 may be formed at the same time or different times, and a number of base portions 16 may be formed at the same time or different times, and any one of these tip portions 14 and any one of these base portions 16 may be used in the other steps shown in FIG. 4 and described below.

As shown in FIG. 4, in Step 430 base portion 16 may be connected to wheel rim 11. For example, base portion 16 may be welded to a surface of wheel rim 11. Base portion 16 is not limited to being welded to wheel rim 11, however, and instead may be connected by another method. For example, base portion 16 may be mechanically fastened (e.g., bolted), adhered (e.g., glued), or otherwise connected to wheel rim 11. Thus, base portion 16 is not limited in how it is connected to wheel rim 11.

In Step 440, tip portion 14 may be connected to base portion 16, to thereby form wheel tip assembly 12. For example, tip portion 16 may be brazed to base portion 16. Examples of filler materials that may be used while brazing the white cast iron tip portion to the steel base portion may include, but are not limited to, aluminum-silicon, copper, copper-phosphorus, copper-zinc (such as but not limited to brass), and/or nickel alloy, as well as combinations of one or more of these materials.

Brazing tip portion 14 to base portion 16 may provide advantages compared to the method in which a white iron tip portion is cast directly onto a base portion. For example, in accordance with the disclosure, either or both of tip portion 14 and base portion 16 may be formed as a hollow body. Thus, wheel tip assembly 12 may be relatively lighter as compared to a comparably-sized directly-cast assembly. Further, when tip portion 14 becomes worn or breaks off of base portion 16 during use of wheel tip assembly 12, a replacement tip portion 14 may be brazed to base portion 16 without replacement of the entire wheel tip assembly 12. Still further, tip portion 14 may be strengthened by heat treatment. In accordance with the disclosure, tip portion 14 may be heat treated prior to being connected to base portion 16. Alternately, tip portion 14 may be heat treated simultaneously with the brazing to base portion 16. Forming one or both of tip portion 14 and base portion 16 as hollow bodies may prevent the connection therebetween from being weakened even when tip portion 14 is heat treated after having been connected (e.g., brazed) to base portion 16. Consistent with the disclosure, tip portion 14 need not be heat treated, however.

Brazing tip portion 14 to base portion 16 also may provide advantages compared to the method in which a white cast iron tip portion is welded to a steel base portion. For example, brazing may be performed at a relatively lower temperature than that at which welding takes place. Thus, brazing of tip portion 14 to base portion 16 may be more easily accomplished as compared to a welded connection. Further, the lower temperature used while brazing may result in one or more of the following: less alteration of physical properties of base portion 16 and/or tip portion 14, or less distortion, warping, and/or stresses in the connection between tip portion 14 and base portion 16, any or all of which may occur when attempting to weld white cast iron to steel.

In accordance with the disclosure, Steps 430 and 440 may be carried out at the same time, or may be carried out at different times. Further, the steps may occur in any order, such that tip portion 14 may be connected to base portion 16 (Step 440) prior to or after connecting base portion 16 to wheel rim 11 (Step 430). Thus, a complete wheel tip assembly 12 may be connected to wheel rim 11, by welding base portion 16 of the complete wheel tip assembly 12 to wheel rim 11 (Step 430), or alternately base portion 16 may be welded to wheel rim 11 (Step 430) and thereafter tip portion 14 may be brazed to base portion 16 previously-welded to wheel rim 11 (Step 440). Also consistent with the disclosure, base portion 16 may be connected to wheel rim 11 (Step 430) prior to formation of tip portion 14 (Step 410), and tip portion 14 may then be formed (Step 410) and subsequently connected to base portion 16 (Step 440). Therefore, the steps shown in FIG. 4 are not limited to being carried out in any particular order.

The steps shown in FIG. 4 may be repeated with additional tip portions 14 and additional base portion 16, such that compactor wheel assembly 10 may include wheel rim 11 with multiple wheel tip assemblies 12 connected thereto. As discussed above, compactor wheel assembly 10 is not limited to having a particular number of wheel tip assemblies 12 connected to wheel rim 11. For example, compactor wheel assembly 10 may have more or fewer wheel tip assemblies 12 than are shown in FIG. 1. Also, the steps shown in FIG. 4 may be repeated on additional wheel rims 11, to provide a plurality of compactor wheel assemblies 10 for use on a soil or landfill compactor, or any other compactor or mobile machine.

It will be apparent to those skilled in the art that various modifications and variations can be made to the disclosed compactor wheel assembly and/or disclosed method of forming and assembling components of the compactor wheel assembly. Other embodiments of the described compactor wheel assembly will be apparent to those skilled in the art from consideration of the specification and practice of the assembly and method disclosed herein. It is intended that the specification and examples be considered as exemplary only, with a true scope being indicated by the following claims and their equivalents.

What is claimed is:

1. A method of forming a wheel tip assembly for a compactor wheel assembly used on a compactor machine, the method comprising:
forming a tip portion of white cast iron;
forming a base portion configured to be connected to a wheel rim; and
brazing the tip portion to the base portion to thereby form the wheel tip assembly.

2. The method of claim 1, wherein forming the base portion includes forming the base portion of a material capable of being welded to the wheel rim.

3. The method of claim 1, wherein forming the base portion includes forming the base portion of a low carbon, low alloy steel.

4. The method of claim 1, wherein brazing includes using a filler material including aluminum-silicon, copper, copper-phosphorus, copper-zinc, or nickel alloy.

5. The method of claim 1, further including:
heat treating the white cast iron.

6. The method of claim 5, wherein heat treating occurs simultaneously with brazing.

7. The method of claim 5, wherein heat treating occurs prior to brazing.

8. The method of claim 1, wherein forming the tip portion includes forming a hollow tip portion, and forming the base portion includes forming a hollow base portion.

9. A method of forming a compactor wheel assembly for use on a compactor machine, the method comprising:
forming a wheel tip assembly by:
forming a tip portion of white cast iron;
forming a base portion configured to be connected to a wheel rim; and
brazing the tip portion to the base portion to thereby form the wheel tip assembly; and
connecting the wheel tip assembly to the wheel rim.

10. The method of claim 9, wherein connecting the wheel tip assembly includes welding the base portion to the wheel rim.

11. The method of claim 9, wherein forming the base portion including forming the base portion of a low carbon, low alloy steel, and
connecting the wheel tip assembly includes welding the base portion to the wheel rim.

12. The method of claim 9, wherein brazing includes using a filler material including aluminum-silicon, copper, copper-phosphorus, copper-zinc, or nickel alloy.

13. The method of claim 9, wherein the tip portion is heat treated simultaneously with brazing.

14. The method of claim 9, wherein the tip portion is heat treated prior to brazing.

15. The method of claim 9, further including:
forming a plurality of additional wheel tip assemblies; and
welding the additional wheel tip assemblies to the wheel rim.

16. A method of forming a compactor wheel assembly for use on a compactor machine, the method comprising:
forming a tip portion of a wheel tip assembly, the tip portion being formed of white cast iron;
forming a base portion of the wheel tip assembly;
connecting the base portion to a wheel rim; and
brazing the tip portion to the base portion previously-connected to the wheel rim, to thereby form the wheel tip assembly.

17. The method of claim 16, wherein forming the base portion including forming the base portion of a low carbon, low alloy steel, and
connecting the base portion includes welding the base portion to the wheel rim.

18. The method of claim 16, wherein the tip portion is heat treated simultaneously with brazing.

19. The method of claim 16, wherein the tip portion is heat treated prior to brazing.

20. The method of claim 16, further including:
forming a plurality of additional tip portions, the additional tip portions being formed of white cast iron;
forming a plurality of additional base portions;
welding the plurality of additional base portions to the wheel rim; and
brazing the plurality of additional tip portions to the plurality of additional base portions previously-welded to the wheel rim.
